(19) United States
(12) Patent Application Publication
(10) Pub. No.: US 2007/0020398 A1
(43) Pub. Date: Jan. 25, 2007

(54) Method for manufacturing water repellent fabrics by use of metal oxide colloidal

(76) Inventors: Pui-Leng Lai, Tucheng City (TW); Chin-Hung Lin, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/267,137

(22) Filed: Nov. 7, 2005

(30) Foreign Application Priority Data
Jul. 22, 2005 (TW) 094124928

(51) Int. Cl. B05D 3/02; B05D 1/18

(52) U.S. Cl. 427/393.4; 427/430.1; 427/372.2

(57) ABSTRACT

A method for manufacturing water repellent fabrics by use of metal oxide colloidal solutions is disclosed. The fabric is dipped and processed in metal oxide colloidal solution and then is through heat treatment so as to make the fabrics with surface roughness on nanometer scale. Then through water repellent treatment, the fabrics has surface with water contact angle above 150°. The water droplets rolls off on fabrics surface and carry away contaminants so as to achieve self-cleaning effect.

### BACKGROUND OF THE INVENTION

The present invention relates to a method for manufacturing water repellent fabrics by use of metal oxide colloid, especially to a method for manufacturing super water repellent fabrics that produce self-cleaning fabrics with features of water repellency, oil repellency, and soil release.

Conventional water repellent finishing obtains lower surface energy by adding organic compound with fluorocarbons or alkoxysilanes. Thus the water contact angle on the surface is increased. Generally, water repellent fabric contact angle is less than 100°, while through treatment with fluorocarbon polymers based finishing products, water contact angle is advanced to 120°. However, surface contaminants still can't be moved because that water droplets can't be formed and roll off. Recently, researchers develop a new product by perfluroalkylsilanes, water contact angle is more than 150°. However, perfluroalkylsilanes compound is very expansive.

Refer to U.S. Pat. No. 3,931,428-Substrate coated with super-hydrophobic layers, the surface of the substrate is coated with calcination silicon dioxide and resinous binder while the surface of substrate is a super-hydrophobic face with highly abrasion, scratch resistance, and good adhesion force. Furthermore, refer to PCT patent No. WO0014323, Textile articles or clothing having super hydrophobic coating, textiles are coated by means of modulated plasma deposition of fluorocarbons so as to have super hydrophobicity. The static water contact angle (WCA) is more preferably higher than 150 degrees. The textiles are preferably subjected to a modulated glow discharge plasma treatment performed with a fluorocarbon gas or vapor compound fed in a properly configured reactor vessel where the textiles are positioned. The plasma process deposits a continuous, fluorocarbon thin film with super hydrophobic surface characteristics, tightly bound to the surface of the textiles. Refer to US patent publication No. 20040154106-Flat textile structures with self-cleaning and water-repellent surfaces, the disclosed aluminum oxide or silicon dioxide particles having an average particle diameter of 0.02 to 100 μm are securely bonded to a base material by treatment with alkylsilanes or the fluoroalkylsilanes without adhesives, resins or coatings. Therefore fabric with water repellent surface and self-cleaning function is obtained.

Moreover, a method for preparation of surfaces with self cleaning properties by application of two-dimentional particles to the surface and fixing of the particles to the surface of textile or plastic material by a hot air stream so as to have surface structure with lotus effect is disclosed. And European patent No. 1283296, Textile fabric with reduced soiling properties, the particles disclosed therein have a diameter of 0.5-100 μm, in combination with one fluorine-free conventional polymer binder, at least one fluoroorganic polymer (FP) or a mixture of this with a hydrophobic wax, where the FP content of component (II) is at least 1 wt % are coated on surface of the flax structured textiles so as to produce self-cleaning effect.

In order to overcome the problems of water contact angle and roll angle, the present invention provides fabric surface with a regular roughness with features on the scale of nanometers and combine with conventional water repellent agent to mimic lotus leaf surface so as to have super water repellent surface structure.

### SUMMARY OF THE INVENTION

Therefore it is a primary object of the present invention to provide a method for manufacturing water repellent fabrics by use of metal oxide colloidal solutions that produces Metal oxide colloid synthesis by sol-gel process and then the fabrics is treated with conventional water repellent agent so that the surface of the fabric has self-cleaning abilities as well as water repellent, oil repellent and soil releasing properties while the hand feel and the color are still intact.

It is another object of the present invention to provide a method for manufacturing water repellent fabrics by use of metal oxide colloidal-solutions that adds chelating agent during the sol-gel synthesis process of the metal oxide colloidal solutions. Then by various coordinations with metal ions, the fixation of metal irons is achieved. The fabric is dipped into the metal oxide colloidal solution. Next the chelating agent is removed by heat treatment. Thus the fabric has optimum surface roughness on nanometer scale. Then after being processed by the water repellent agent, the surface of the fabric has self-cleaning abilities.

In order to achieve above objects, a method for manufacturing water repellent fabrics by use of metal oxide colloidal solutions in accordance with the present invention is disclosed. The fabric is dipped into a metal oxide colloidal solution directly and then is through heat treatment for generating roughness surface with features on the scale of nanometers. Next by the water repellent treatment, the roughness surface of the fabric has water contact angle of more than 150°. Thus the surface contaminants on the fabric are moved by fine water droplets. Therefore, the fabric has self-cleaning function.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a manufacturing flow chart of an embodiment in accordance with the present invention.

FIGS. 2 and 3 are FE-SEM photographs of the surface of metal oxide coating film before and after heat treatment.

### DETAILED DESCRIPTION OF THE PREFERRED EMBODIMENT

The present invention forms granules on nanometer scale on surface of flowerlike surface of the lotus leaf so as to have super hydrophobic surface. Because roughness on nanometer scale on fabric surface are quite small, there is no effect on hand-feeling of the fabric. Moreover, the chelating agent is added into the colloidal solutions of metal oxide during the synthesis process, the metal iron is fixed by various coordinations. Then the fabric is heated so as to have condensation reaction and elimination reaction, generation a thin film of metal oxide with transparency over 90% is formed on surface of the fabric. Due to excellent transparency, the thin film won't cause problem of chromatic aberration.

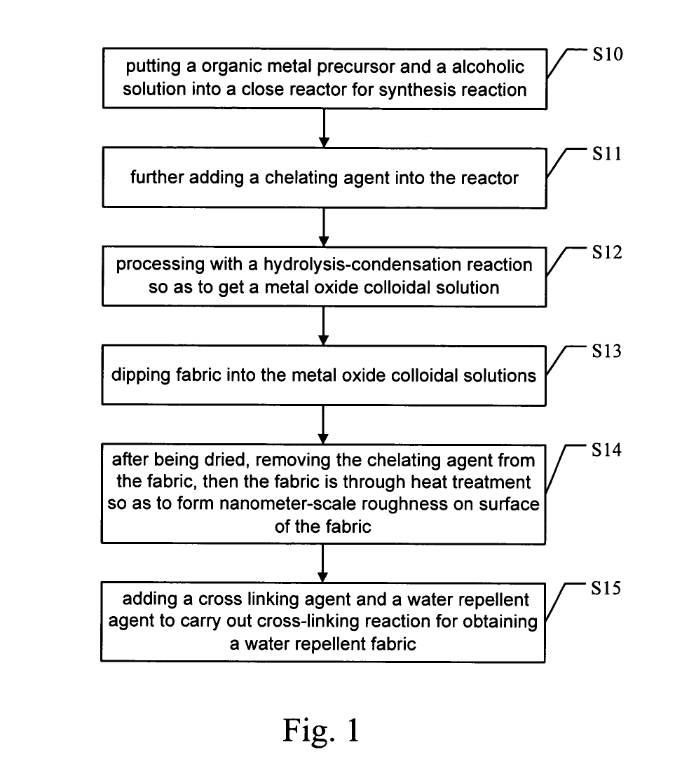

Refer to FIG. 1, a manufacturing flow chart of the present invention includes the steps of:

step S10, putting a organic metal precursor and a alcoholic solution into a close reactor for synthesis reaction;

step S11, further adding a chelating agent into the reactor;
step S12, processing with a hydrolysis-condensation reaction so as to get a metal oxide colloidal solution;
step S13, dipping fabric into the metal oxide colloidal solutions;
step S14, after being dried, removing the chelating agent from the fabric, then the fabric is through heat treatment so as to form nanometer-scale roughness on surface of the fabric; and
step S15, adding a cross linking agent and a water repellent agent to carry out cross-linking reaction for obtaining a water repellent fabric.

In step S10, the metal oxide inside metal organic precursor is selected from one of the followings: aluminum oxide, zirconium oxide, and titanium oxide. The metal oxide contained in the metal organic precursor is from 1 to 20 mole percent. In step S11, the chelating agent is selected from one of the followings: ethyl acetoacetate, diethylene glycol, and diethanolamine. In step S15, the water repellent agent is one of the followings: alkanes, alkoxysilane, urethane ethylene, melamine, and fluorocarbonate.

Moreover, in step S15, the roughness on nanometer scale ranges from 1˜100 nm. In step S14, the heat treatment temperature lies between 60 degrees and 80 degrees Celsius while the heat treatment time ranges from 5 to 20 minutes.

An experiment is taken as an example:

(A) A Method of Preparing Aluminum Oxide:

Add 1-100 g and 400 g alcoholic solution into a closed glass reactor and then process the glass reactor into a water bath in room temperature and stir the reactants for 20˜40 minutes. Add 50 g chelating agent into the reactor and react for 1˜3 hours. Then mix 30 g deionized water with 100 g alcoholic solution and slowly drop the mixture into the reactor so as to make the precursor have hydrolysis-condensation reaction for 20˜40 minutes. Thus the colloidal solution of aluminum oxide is prepared.

(B) A Method of Preparing Water Repellent fabrics:

Various fabrics such as cotton, non-woven fabrics, and artificial leather made by PVC are dipped into the colloidal solution of aluminum oxide, dried at room temperature, and then immersed into the hot water for 5˜20 minutes so as to remove the chelating agent. Next the fabric is heated at 60 □ so that the surface roughness is produced. By usage of the water repellent agent and cross-linking agent, the fabric processed by the aluminum oxide is dipped again, dried at 80˜120 □ for 30˜90 minutes and then finishing (setting) at 130˜1701 □ for 5˜10 minutes so as to make the water repellent agent cross-links with the fabric. Therefore, the water repellent fabric is produced. The water contact angle on fabric surfaces are listed in the following chart:

| | | | processed by |
|---|---|---|---|
| | | | aluminum |
| | | water | oxide + water |
| | | repellent | repellent |
| textile | unprocessed | finish | agent |
| cotton | water | 140 | 155 |
| | absorbance | | |
| artificial | <100 | 127 | 136 |
| leather | | | |
| made by | | | |
| PVC | | | |
| non-woven | <120 | 133 | 144 |
| fabrics | | | |

The results show that the untreated fabric has no water repellency while the fabric treated with the water repellent finish is water repellent but not super-water-repellent. Being processed by aluminum oxide, a nanometer-scale roughness is formed on fabric surface. In combination with the water repellent finish, water droplets form spherical globules on surface of the fabric. The water contact angle of cotton fabric is larger than 150 degrees so as to produce the super water repellent effect.

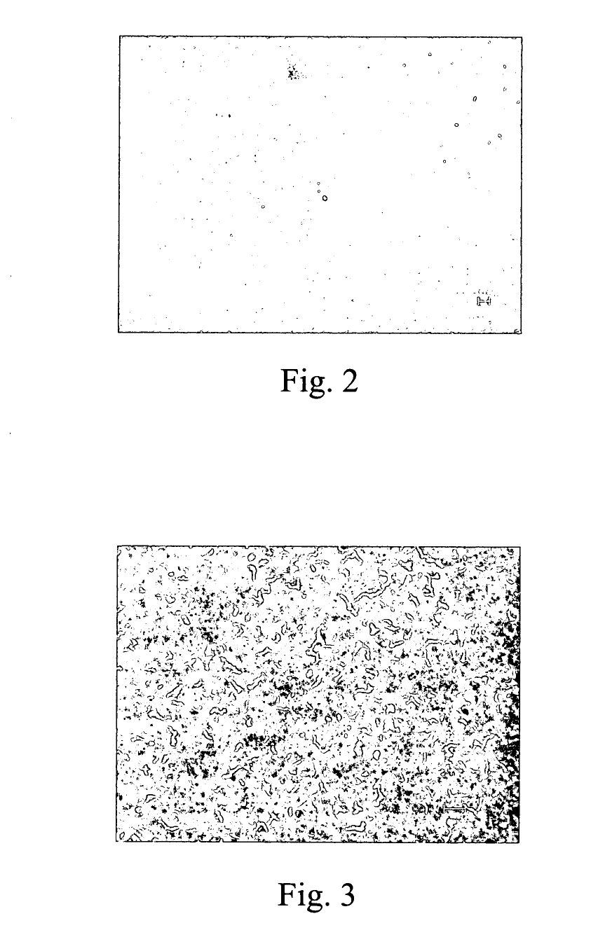

Refer to FIGS. 2 and 3, the fabric dipped with metal oxide before heat treatment is displayed smooth surface as showing in FIG. 2. the fabric dipped with metal oxide after heat treatment is displayed flowerlike roughness surface as showing in FIG. 3.

The following chart shows results of soil release, oil repellency, and water repellency tests on fabrics reacting with aluminum oxide and water repellent agent.

| | test result | |
|---|---|---|
| | fabrics + aluminum | |
| | oxide + water | |
| test item | repellent agent | test method |
| soil release | 3.3 | AATCC 130-2000 II |
| oil | 5 | AATCC 118-2002 |
| repellency | | |
| water | 90 | AATCC 22-2001 |
| repellency | | environmental |
| | | conditions: 30□, |
| | | 59% R.H. |

The results show that the fabric treated by aluminum oxide as well as water repellent agent is with water contact angle of more than 150 degrees, the soil release higher than grade 3, the oil repellency equal to or higher than grade 5, and the water repellency equal to or higher than 90 marks so that the fabric surface has self-cleaning effect.

Furthermore, the following description explains how the present invention has not effect on the hand-feeling of the fabric.

The reactant aluminum butoxide includes linear tripolymer, wherein one aluminum atom has five coordination bonds and other two aluminum atoms provide four. When ethyl acetoacetate is used as chelating agent, the aluminum atom therein is six-coordinated. One of the aluminum atoms is coordinated with two ethyl acetoacetate while another aluminum atom is coordinated with one ethyl acetoacetate. Thus the aluminum atoms are fixed by the chelating agent after the reaction. When the fabric is treated and dried on surface directly, an aluminum oxide film with transparency higher than 90% forms by the condensation reaction. By treatment of hot water, the ethyl acetoacetate is removed and the nanometer-scale roughness by fixed and aligned aluminum oxide is obtained. There is no agglomeration or separation on the fabric surface. Thus the roughness on nanometer scale has no effect on the hand-feeling of the fabric and there is no chromatic aberration due to high transparency of the aluminum oxide thin film.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for manufacturing water repellent fabrics by use of metal oxide colloidal solutions comprising the steps of:
putting a organic metal precursor and a alcoholic solution into a close reactor for synthesis reaction;
further adding a chelating agent into the reactor;
processing with a hydrolysis-condensation reaction so as to get a metal oxide colloidal solution;
dipping fabric into the metal oxide colloidal solutions;
after being dried, removing the chelating agent from the fabric, then the fabric is through heat treatment so as to form nanometer-scale roughness on surface of the fabric; and
adding a cross linking agent and a water repellent agent to carry out cross-linking reaction for obtaining a water repellent fabric.

2. The method as claimed in claim 1, wherein metal oxide of the organic metal precursor is selected from the group having aluminum oxide, zirconium oxide, and titanium oxide.

3. The method as claimed in claim 2, wherein the metal oxide contained in the organic metal precursor is from 1 to 20 mole percent.

4. The method as claimed in claim 1, wherein the chelating agent is selected from the group having ethyl acetoacetate, diethylene glycol, and diethanolamine.

5. The method as claimed in claim 1, wherein the water repellent agent is selected from the group having alkanes, alkoxysilane, urethane ethylene, melamine, and fluorocarbonate.

6. The method as claimed in claim 1, wherein the nanometer-scale roughness is from 1 nm to 100 nm.

7. The method as claimed in claim 1, wherein temperature of the heat treatment is from 60 to 80 degrees Celsius while time of the heat treatment ranges from 5 to 20 minutes.

8. The method as claimed in claim 1, wherein temperature of the cross-linking reaction is from 130 to 170 degrees Celsius while time of the cross-linking reaction ranges from 5 to 10 minutes.

9. A method for manufacturing water repellent fabrics by use of metal oxide colloidal solutions comprising the steps of:
producing a metal oxide colloidal solution by sol-gel process;
dipping fabric into the metal oxide colloidal solutions;
after being dried, removing the chelating agent from the fabric, then the fabric is through heat treatment so as to form nanometer-scale roughness on surface of the fabric; and
adding a cross linking agent and a water repellent agent to carry out cross-linking reaction for obtaining a water repellent fabric.

10. The method as claimed in claim 9, wherein metal oxide of the organic metal precursor is selected from the group having aluminum oxide, zirconium oxide, and titanium oxide.

11. The method as claimed in claim 10, wherein the metal oxide contained in the organic metal precursor is from 1 to 20 mole percent.

12. The method as claimed in claim 9, wherein the chelating agent is selected from the group having ethyl acetoacetate, diethylene glycol, and diethanolamine.

13. The method as claimed in claim 9, wherein the water repellent agent is selected from the group having alkanes, alkoxysilane, urethane ethylene, melamine, and fluorocarbonate selected from the group consisting of

14. The method as claimed in claim 9, wherein the nanometer-scale roughness is from 1 nm to 100 nm.

15. The method as claimed in claim 9, wherein temperature of the heat treatment is from 60 to 80 degrees Celsius while time of the heat treatment ranges from 5 to 20 minutes.

16. The method as claimed in claim 9, wherein temperature of the cross-linking reaction is from 130 to 170 degrees Celsius while time of the cross-linking reaction ranges from 5 to 10 minutes.
